(19) United States
(12) Patent Application Publication
(10) Pub. No.: US 2017/0285370 A1
(43) Pub. Date: Oct. 5, 2017

(54) AUTOMATIC FALSE PUPIL CONTACT LENS

(71) Applicant: Intel Corporation, Santa Clara, CA (US)

(72) Inventor: Terrence P. Leip, Chandler, AZ (US)

(73) Assignee: Intel Corporation, Santa Clara, CA (US)

(21) Appl. No.: 15/083,765

(22) Filed: Mar. 29, 2016

(51) Int. Cl. G02C 7/10; G02C 7/04

(52) U.S. Cl. CPC G02C 7/105; G02C 7/04; G02C 7/101; G02C 7/102; G02C 2202/10; G02C 2202/16

(57) ABSTRACT

In one example an automatic false pupil contact lens comprises a body formed from an optically translucent material and a coating on the body formed from at least one of a photochromatic material or an electrochromatic material that, in response to an input, is to change between a first state in which the coating is optically translucent and a second state in which the coating is optically opaque in response to an input. Other examples may be described.

### BACKGROUND

The subject matter described herein relates generally to the field of electronic devices and more particularly to an automatic false pupil contact lens.

The size of an individual's pupil(s) impacts visual acuity, depth of field, and the ability to recognize objects. If a pupil opening is too large for a given ambient light level then the depth of field is reduced. By contrast, if a pupil opening is too small light rays may experience diffraction when they pass through the pupil, which distorts the field of vision.

Various factors such as genetics, aging, and disease may cause an individual's pupil(s) to dilate in a less than ideal manner, which may result in one or more of the vision issues described above. Accordingly, an automatic false pupil contact lens may find utility, e.g., in managing eyesight issues caused by imperfect pupil dilation.

### BRIEF DESCRIPTION OF THE DRAWINGS

The detailed description is described with reference to the accompanying figures.

FIG. 1 is an illustration of an automatic false pupil contact lens in accordance with some examples in accordance with some examples.

FIGS. 2A, 2B, 2C, 2D, and 2E are schematic illustrations of an automatic false pupil contact lens in various stages of dilation in accordance with some examples.

FIGS. 3A-3B are schematic illustrations of an eyewear apparatus which may be used in conjunction with an automatic false pupil contact lens accordance with some examples.

FIG. 4 is a high-level schematic illustration of a processing platform which may be adapted to implement an automatic false pupil contact lens in accordance with some examples in accordance with some examples.

FIGS. 5A-5B are flowcharts illustrating operations in a method to implement an automatic false pupil contact lens in accordance with some examples in accordance with some examples.

FIGS. 6-10 are schematic illustrations of electronic devices which may be adapted to implement an automatic false pupil contact lens in accordance with some examples in accordance with some examples.

### DETAILED DESCRIPTION

Described herein are exemplary systems and methods to implement an automatic false pupil contact lens in accordance with some examples. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

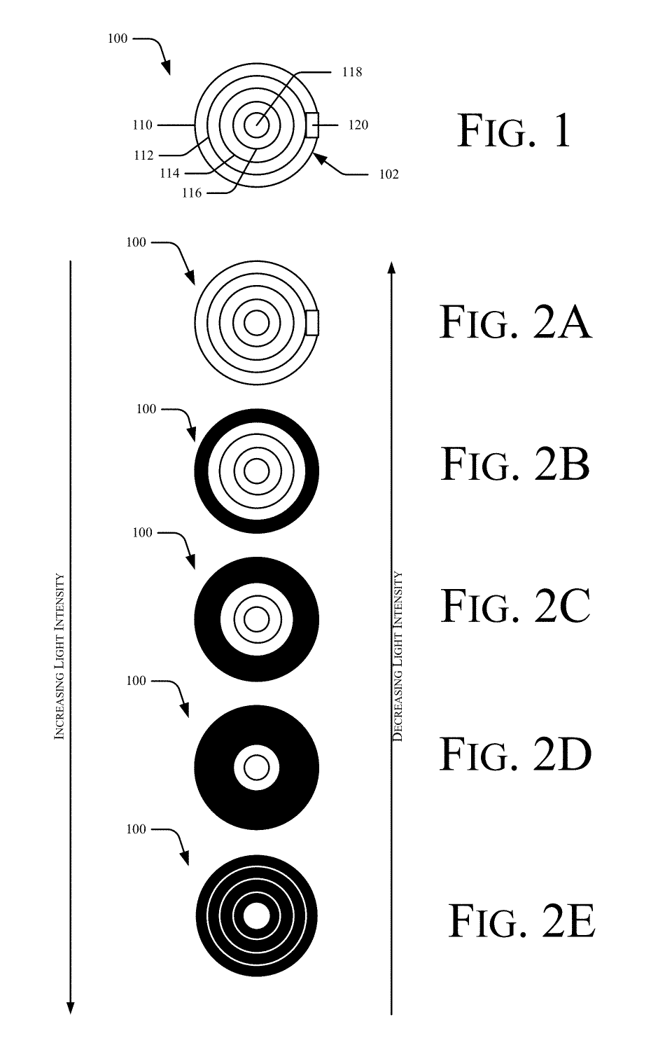

FIG. 1 is an illustration of an automatic false pupil contact lens in accordance with some examples. Referring to FIG. 1, in accordance with principles described herein, an automatic false pupil contact lens 100 comprises a body 102 formed from an optically translucent material and a coating on the body formed from at least one of a photochromatic material or an electrochromatic material that changes between a first state in which the coating is optically translucent and a second state in which the coating is optically opaque in response to an input.

In some examples the body 102 may be formed from at least one of a translucent polymer material or a glass material. The body may be rigid, semi-rigid, or relatively flexible, similar to existing contact lenses.

In some examples the coating comprises a photochromatic material arranged in a plurality of concentric rings indicated by reference numerals 110, 112, 114, and 116 in FIG. 1. The concentric rings may be arranged around a central aperture 118. In some examples the central aperture measures approximately 2 millimeters and the concentric rings each measure approximately 1 millimeter in width. In some examples the concentric rings 110, 112, 114, 116 may be in physical contact with adjacent rings on the body 102, while in other embodiments the concentric rings 110, 112, 114, 116 may be separated by a slight gap, e.g., 0.01 millimeters to 0.1 millimeters. While the example depicted in FIG. 1 comprises four concentric rings 110, 112, 114, 116, one skilled in the art will recognize that the lens 100 may comprise more concentric rings or fewer concentric rings.

In some examples the photochromatic material may comprise a material that darkens upon exposure to specific types of light (e.g., ultraviolet radiation) of adequate intensity. Examples of suitable photochromatic materials may comprise silver chloride, silver halide, or the like. In some examples the coating may comprise a photosensitivity (i.e., a propensity to turn from clear/translucent to opaque) which varies between the respective concentric rings. This may be accomplished, e.g., by varying the thickness of the photochromatic material in the respective concentric rings 110, 112, 114, 116 or by varying the concentration of photochromatic material in the coating in the respective concentric rings 110, 112, 114, 116.

In some examples the photosensitivity of the photochromatic material increases in successively larger concentric rings. Thus, in the embodiment depicted in FIG. 1 the innermost concentric ring 116 has the lowest photosensitivity, while the second concentric ring 114 has the second lowest photosensitivity, the third concentric ring 112 has the third lowest photosensitivity, and the fourth concentric ring 110 has the fourth lowest sensitivity, etc.

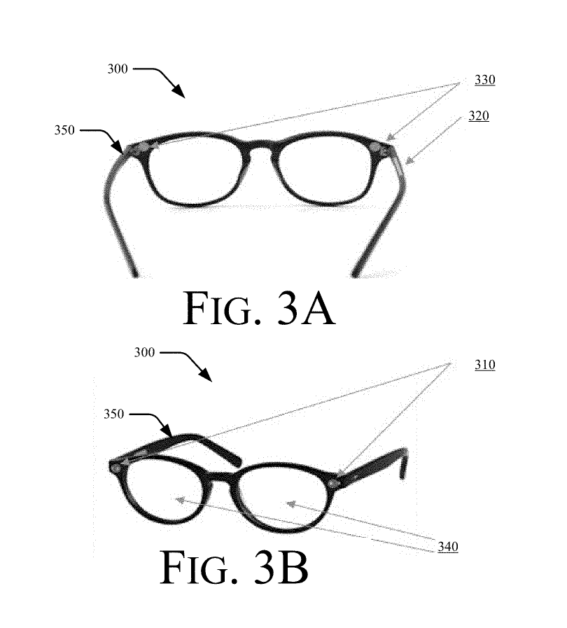

Thus, as illustrated in FIGS. 2A-2E, as the intensity of light impinging on lens 102 increases from an low-level intensity in which the photochromatic material on all of the concentric rings 110, 112, 114, 116 is in a translucent state (FIG. 2A) to slightly higher level of intensity (FIG. 2B) the photochromatic material on the first concentric ring 110 is activated and the first concentric ring changes from a translucent state to a substantially opaque state, thereby reducing the translucent portion of the lens. As the intensity of light continues to increase successive concentric rings 112, 114, 116 change from a translucent state to a substantially opaque state, thereby reducing the translucent portion of the lens, as illustrated in FIG. 2B-2E.

Conversely, as illustrated in FIGS. 2A-2E, as the intensity of light impinging on lens 102 decreases from an high-level intensity in which the photochromatic material on all of the concentric rings 110, 112, 114, 116 is in an opaque state (FIG. 2E) to slightly lower level of intensity (FIG. 2D) the photochromatic material on the fourth concentric ring 116 is deactivated and the fourth concentric ring 116 changes from an opaque state to a substantially translucent state, thereby increasing the translucent portion of the lens. As the intensity of light continues to decrease successive concentric rings 114, 112, 110 change from a substantially opaque state to a translucent state, thereby increasing the translucent portion of the lens, as illustrated in FIG. 2D-2A.

Thus, the concentric rings 110, 112, 114, 116 of photochromatic material enable the lens 110 to emulate a pupil. Increased light intensity results in a narrowing of the substantially translucent aperture and, conversely, decreased light intensity results in a widening of the substantially translucent aperture.

In another example the coating comprises a photosensitivity which increases in a continuous manner as a function of distance from a central point (e.g., a central point in the central aperture 118 of the lens) on the body 102 of the lens 100, as opposed to concentric rings which may have discrete levels of photosensitivity. This may be accomplished, e.g., by varying the thickness of the photochromatic material in a continuous manner as a function of distance from a central point or by varying the concentration of photochromatic material in a continuous manner as a function of distance from a central point. Thus, in the embodiment depicted in FIG. 1 the inner portions of the leans surrounding the central aperture 118 would have the lowest photosensitivity, while the outer portions of the lens have a higher photosensitivity.

In another example the coating comprises an electrochromatic material arranged in a plurality of concentric rings indicated by reference numerals 110, 112, 114, and 116 in FIG. 1. In some examples the electrochromatic material may comprise a material that changes between a translucent state and a substantially opaque state upon exposure to an electrical impulse. Examples of suitable electrochromatic materials may comprise tungsten oxide, or the like. In some examples the coating may comprise an electrosensitivity (i.e., a propensity to turn from clear/translucent to opaque) which varies between the respective concentric rings. This may be accomplished, e.g., by varying the thickness of the electrochromatic material in the respective concentric rings 110, 112, 114, 116 or by varying the concentration of electrochromatic material in the coating in the respective concentric rings 110, 112, 114, 116.

In some examples the electrosensitivity of the electrochromatic material increases in successively larger concentric rings. Thus, in the embodiment depicted in FIG. 1 the innermost concentric ring 116 has the lowest electrosensitivity, while the second concentric ring 114 has the second lowest electrosensitivity. the third concentric ring 112 has the third lowest electrosensitivity, and the fourth concentric ring 110 has the fourth lowest electrosensitivity, etc. In such examples the electrical impulse applied to the concentric rings varies as a function of the electrosensitivity of the coating in the respective concentric rings.

In other examples the coating may comprise an electrosensitivity which is consistent between the respective concentric rings 110, 112, 114, 116. In such examples the electrical impulse applied to the concentric rings 110, 112, 114, 116 may be consistent across the respective concentric rings 110, 112, 114, 116.

In some examples the lens 100 may comprise one or more electrical impulse generator(s) 120 to generate one or more electrical impulses to activate the electrochromatic material on the lens 100. In some examples the electrical impulse generator(s) 120 may comprise a passive device, e.g., an electromagnetic resonator, an inductive resonator or the like, electrically coupled to the electrochromatic material on the respective concentric rings 110, 112, 114, 116. In one example the lens 100 may comprise a plurality of electrical impulse generators, each of which resonates at a different frequency and is electrically coupled to one of the respective concentric rings 110, 112, 114, 116.

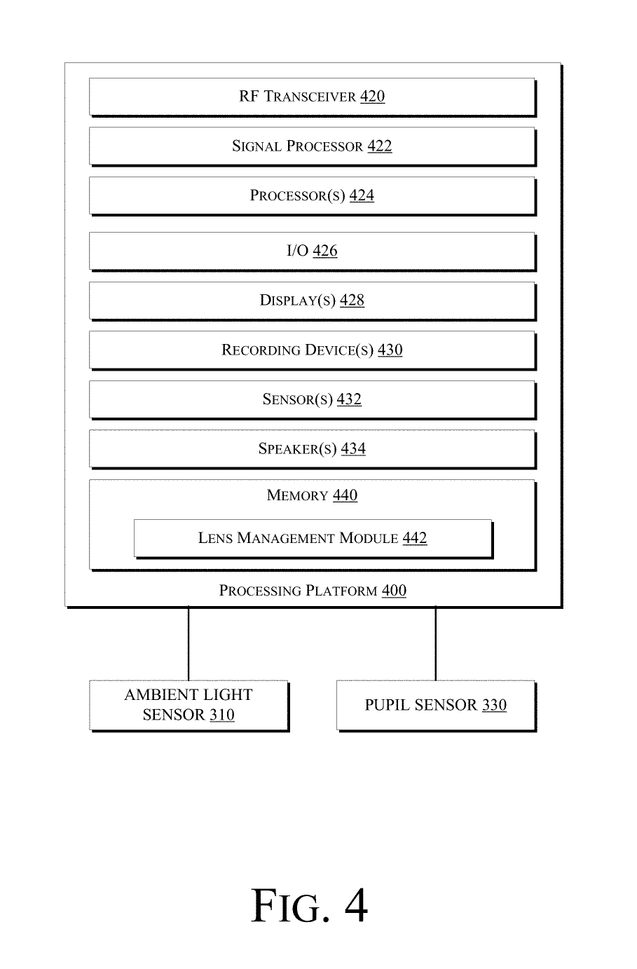

In some examples a lens 100 configured with an electrochromatic material may cooperate with an electronic device to implement a configurable automatic false pupil contact lens. Referring to FIGS. 3A-3B, in some examples the electronic device 300 may be incorporated into a wearable device such as eyeglasses 350 and may comprise at least one light sensor 310 to detect an ambient light condition, a pupil sensor 330, and a controller 320 comprising logic, at least partially including hardware logic, to receive an input from the at least one light sensor 310, wherein the input indicates the ambient light condition, determine an appropriate pupil size in the lens 100 for the ambient light condition, and in response to a determination that a difference between the appropriate pupil size and a current pupil size is not within a threshold, to generate a pupil size signal to be transmitted to the automatic false pupil contact lens 100. In one example, the pupil size signal can be transmitted to electrical impulse generator(s) 120 of lens 100.

In the example depicted in FIGS. 3A-3B the light sensor(s) 310 may be mounted on a front side of the glasses 350 proximate the lenses 340 of the glasses. The controller 320 may be mounted on one of the arms of the glasses. Further, one or more pupil size sensors 330 may be mounted on the frame of the glasses 350.

In other examples the controller 320, light sensor(s) 330 and pupil size sensor(s) 330 may be mounted on other wearable device, e.g., an earpiece, a hat, headband, bracelet, necklace, or the like. In further examples the controller 320, light sensor(s) 330 and pupil size sensor(s) 330 may be implanted subcutaneously.

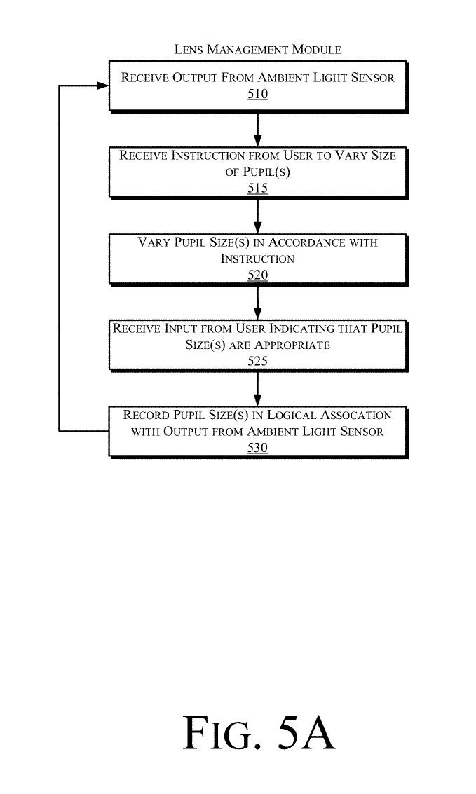

FIG. 4 is a schematic illustration of components of a processing platform 400 which may be adapted to implement the controller 320 in an automatic false pupil contact lens in accordance with some examples. As described above, in some aspects processing platform 400 may be integrated into a wearable device such as a pair of glasses, an earpiece, a helmet, a headband, or the like. The specific implementation of the processing platform 200 is not critical. In one example the processing platform 400 may be implemented as an Intel® Curie™ platform.

In some examples processing platform 400 may include an RF transceiver 420 to transceive RF signals and a signal processing module 422 to process signals received by RF transceiver 420. RF transceiver 420 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Processing platform 400 may further include one or more processors 424 and memory 440. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some examples, processor 424 may be one or more processors in the family of processors available from Intel® Corporation of Santa Clara, Calif. Alternatively, other processors may be used, such as Intel's Itanium®, XEON™, ATOM™, and Celeron® processors. Also, one or more processors from other manufactures may be utilized. Moreover, the processors may have a single or multi core design.

In some examples, memory 440 includes random access memory (RAM); however, memory module 440 may be implemented using other memory types such as dynamic RAM (DRAM), synchronous DRAM (SDRAM), and the like. Memory 440 may comprise one or more applications which execute on the processor(s) 424.

Processing platform 400 may further include one or more input/output (I/O) devices 426 such as, e.g., a touchpad, buttons, microphone, or the like, and one or more displays 428, speakers 434, and one or more recording devices 430. By way of example, recording device(s) 430 may comprise one or more cameras and/or microphones

Processing platform may include one or more sensors 432 adapted to detect at least one of an acceleration, an orientation, or a position of the sensor, or combinations thereof. For example, sensors 432 may comprise one or more accelerometers, gyroscopes, magnetometers, piezoelectric sensors, or the like.

In some examples a lens management module 442 may reside in memory 440 of processing platform 400. Lens management module 442 may be embodied as logic instructions which, when executed on a processor, such as processor 424, configure the processing platform to perform operations to implement an automatic false pupil contact lens.

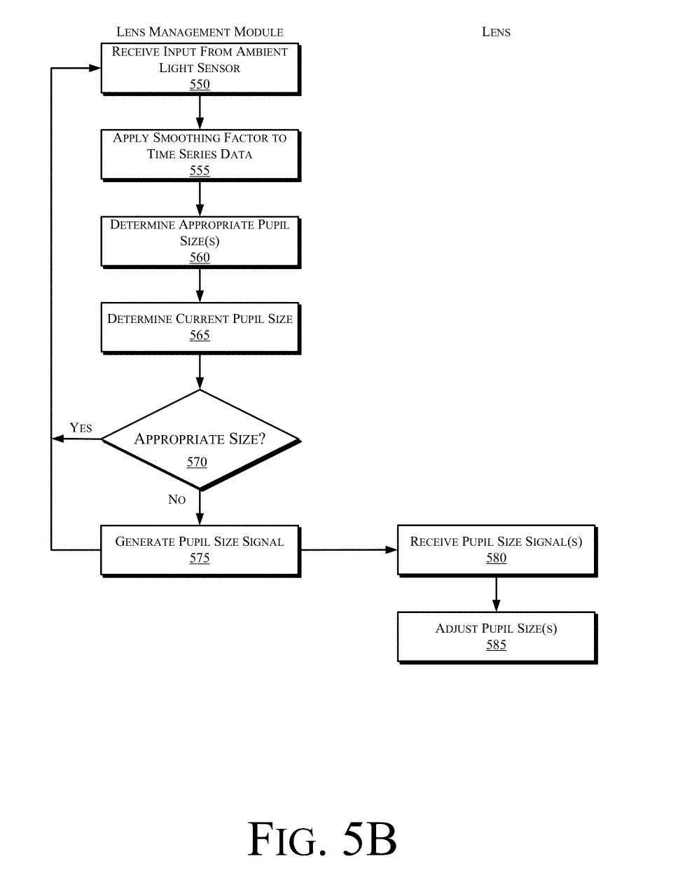

FIGS. 5A-5B are flowcharts illustrating operations in a method to implement an automatic false pupil contact lens in accordance with some examples in accordance with some examples. In some examples a user may implement a training algorithm which enables the processing platform 400 to correlate a variety of ambient light conditions with pupil size signals to be transmitted from the processing platform to the electrical impulse generator(s) 120 in the lens 100. To implement the training algorithm a user may be fitted with one or more lenses 100 and electronic device(s) 300 and exposed to a variety of ambient lighting conditions. In one example, a user can provide input to the processing platform 400 which indicates an appropriate pupil size on the lens 100 for the ambient lighting conditions, allowing the processing platform 400 to correlate lighting conditions with pupil size for a specific user. In another example, processing platform 400 may implement a dynamic feedback system in which a the input device(s) on the glasses to adjust the contacts. An algorithm executing in the lens management module 442 can map ambient light and current pupil size to contact opacity. The mapping can be dynamically adjusted whenever the user makes adjustments using the inputs on the glasses.

One example of a training algorithm is depicted in FIG. 5A. In some examples the training algorithm depicted in FIG. 5A may be implemented by the lens management module 442 executing on the processor 424 of the processing platform 400, alone or in combination with other components of processing platform 400. Referring to FIG. 5A, at operation 510 the processing platform 400 receives an output from light sensor(s) 310. In some examples the output from the light sensor(s) 310 may be a voltage differential between the light sensor(s) 310 and a reference voltage, e.g., ground, that is proportional to the intensity of the light input incident on the light sensor(s) 310.

At operation 515 the lens management module 442 receives instructions from a user to vary the size of the pupil(s) on the contact lens(es) worn by the user. For example, a user may signal by an I/O device to increase or to decrease the size of the pupil(s) on the lens(es) worn by the user to accommodate the ambient lighting condition.

At operation 520 the lens management module 442 varies the size of the pupil(s) on the lens(es) worn by the user in accordance with the instructions from the user. For example, in response to an instruction to decrease the size of the pupil(s) on the lens(es) worn by the user the lens management module 442 may generate one or more pupil size signals which are transmitted to the electrical impulse image generator(s) 120 on the lens(es) 100. In response to the pupil size signal(s) the electrical impulse image generator(s) 120 on the lens(es) 100 activate the electrochromatic material on one or more of the respective rings 110, 112, 114, 116 to decrease the size of the pupil(s) 120 on the lens(es) 100.

Conversely, in response to an instruction to increase the size of the pupil(s) on the lens(es) 100 worn by the user the lens management module 442 may terminate the transmission of one or more pupil size signals to the electrical impulse image generator(s) 120 on the lens(es) 100. In response to the termination of the pupil size signal(s) the electrical impulse image generator(s) 120 on the lens(es) 100 cease to apply an electrical current to the electrochromatic material, which deactivates the electrochromatic material on one or more of the respective concentric rings 110, 112, 114, 116 to increase the size of the pupil(s) 120 on the lens(es) 100. Thus, the management module 442 enables a user to selectively increase or decrease the increase the size of the pupil(s) on the lens(es) 100 worn by the user.

At operation 525 the lens management module 442 receives an input from a user to which indicates that the size of the pupil(s) on the lens(es) 100 worn by the user are appropriate for the current lighting conditions. For example, a user may signal by an I/O device that the size of the pupil(s) on the lens(es) worn by the user are appropriate for the current lighting conditions.

At operation 530 the lens management module records the size of the pupil(s) on the lens(es) worn by the user in logical association with the output from the light sensor(s) 310. For example, lens management module 442 may record the output of the light sensor(s) 310 in logical association with the number of respective concentric rings 110, 112, 114, 116 to be activated at the current ambient lighting condition in a table in the memory 440.

During the training process the operations 510-530 may be repeated in a variety of ambient lighting conditions to enable the lens management module 442 to construct a table in memory 440 which correlates the output of the light sensor(s) 310 with the size of the pupil(s) on the lens(es) 100 worn by the user are appropriate for the current lighting conditions.

In use, the lens management module 442 may utilize the table in memory to manage the size of the pupil(s) on the lens(es) 100 worn by the user in various lighting conditions. Referring to FIG. 5B, at operation 550 the lens management module 442 may receive an output from light sensor(s) 310. In some examples the output from the light sensor(s) 310 may be a voltage differential between the light sensor(s) 310 and a reference voltage, e.g., ground, that is proportional to the intensity of the light input incident on the light sensor(s) 310. In some examples the lens management module 442 may sample the output of the light sensor(s) 310 on a periodic basis (e.g., every 1-10 milliseconds) and my record the output in memory 440 to generate a time-series data set of the output of light sensor(s) 310.

At operation 555 the lens management module 442 may apply a smoothing factor to the time series data. By way of example, a smoothing factor may filter high voltage artifacts such as sudden changes in light intensity cause by, e.g., lightning, an explosion, or the like.

At operation 560 the lens management module 442 determines an appropriate pupil size for the user. In some examples the lens management module 442 may search the table in memory 442 for the entry in which the output from the light sensor(s) 310 is closest to the current time-smoothed output reading from the light sensor(s) 310 and may select a number of respective concentric rings 110, 112, 114, 116 to be activated at the current ambient lighting condition from the table in the memory 440.

At operation 565 the lens management module determines the current pupil size. In some examples the current pupil size may be determined from the output of the pupil size sensor(s) 330 which may include an optical sensor to measure the current size of the pupils in the lens(es) 100.

If, at operation 570 the current pupil size corresponds to the appropriate pupil size for the user at the current ambient lighting condition then control passes back to operation 550 and the lens management module 442 continues to monitor the ambient light conditions. By contrast, if at operation 570 the current pupil size does not correspond to the appropriate pupil size for the user at the current ambient lighting conditions then control passes back to operation 575 and the lens management module 442 generates a pupil size signal. In some examples the pupil size signal may be implemented as described above, i.e., by selectively activating or deactivating transmissions to the electrical impulse generator(s) 120 on lens 100.

At operation 580 the pupil size signal(s) are received by the electrical impulse generator(s) 120 on lens 100 which, at operation 585, adjust the size of the pupil(s) in the lens(es) 100 in accordance with the pupil size signal(s). In some examples the lenses 340 of glasses 300 may be coated with an electrochromatic material and the pupil size signal may be applied an actuator coupled to the lenses 340 in order to change the opacity of the lenses 340.

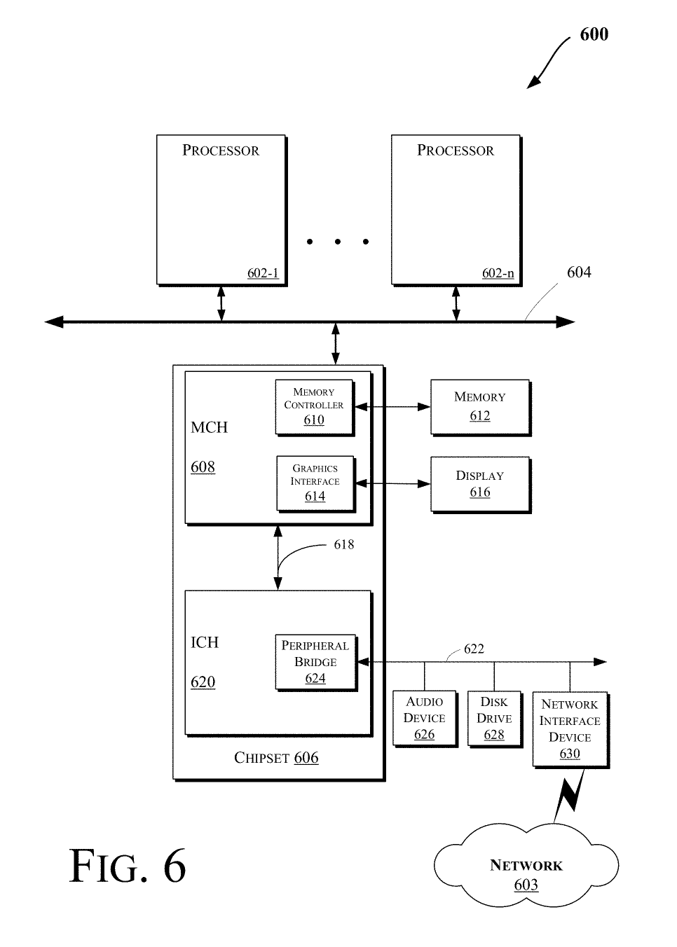

As described above, in some examples the electronic device may be embodied as an information processing system. FIG. 6 illustrates a block diagram of an information processing system 600 in accordance with an example. The information processing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors.

A chipset 606 may also communicate with the interconnection network 604. The chipset 606 may include a memory control hub (MCH) 608. The MCH 608 may include a memory controller 610 that communicates with a memory 612. The memory 612 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the information processing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

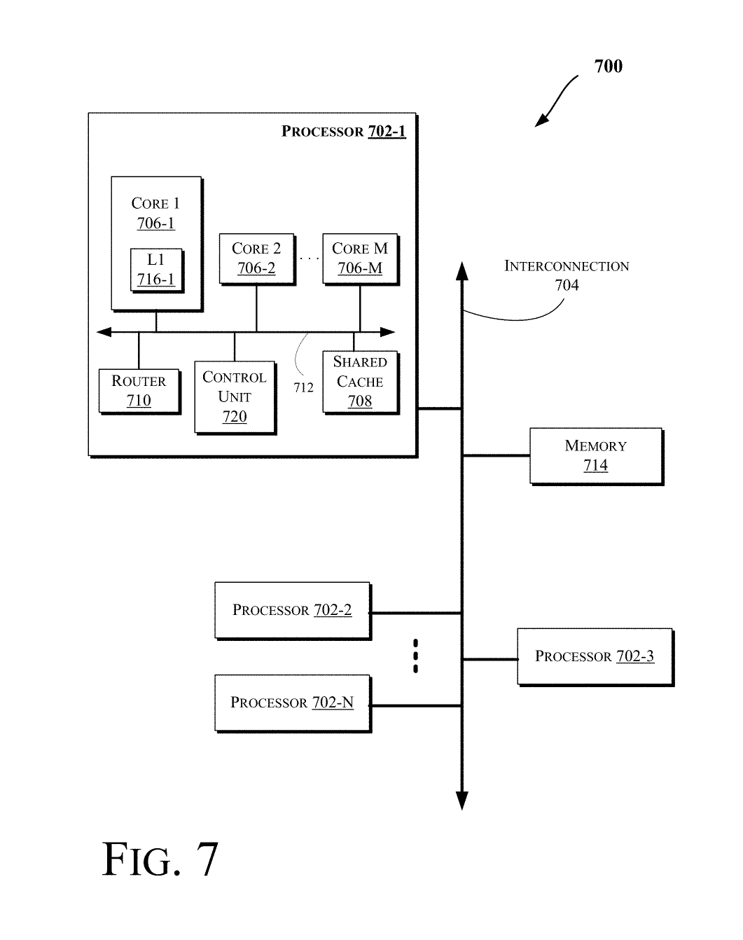

FIG. 7 illustrates a block diagram of an information processing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

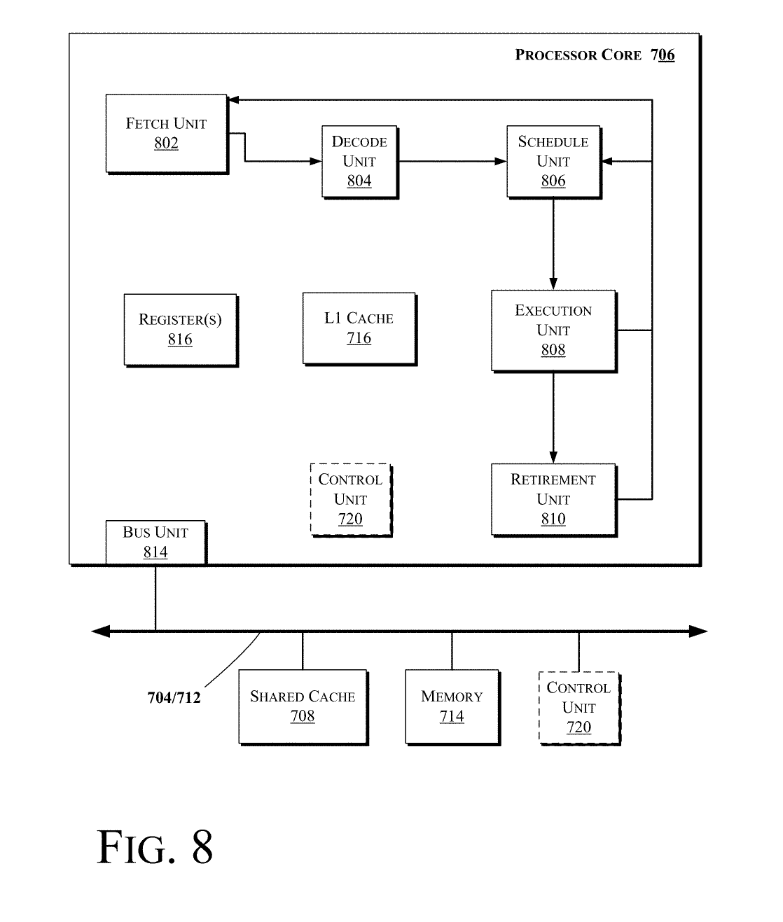

FIG. 8 illustrates a block diagram of portions of a processor core 706 and other components of an information processing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

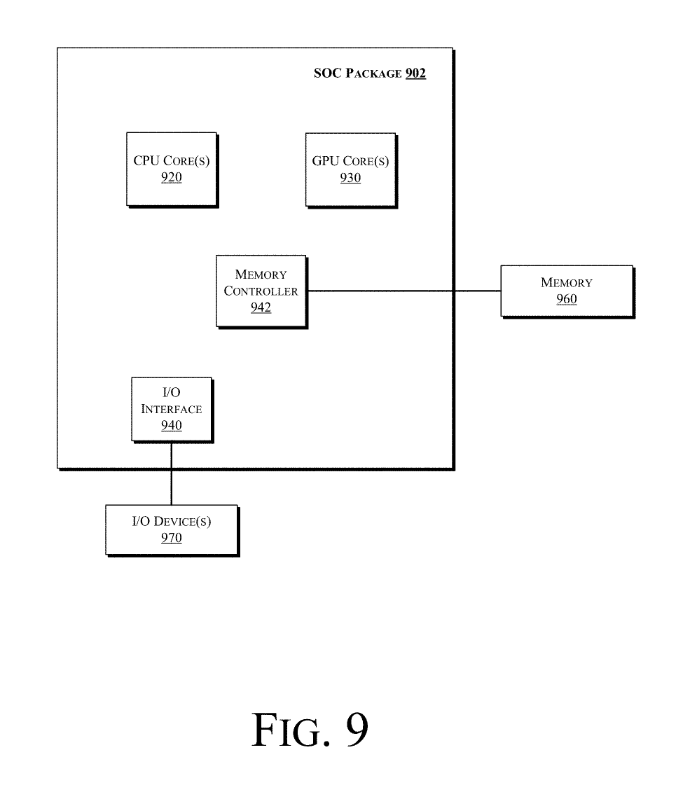

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

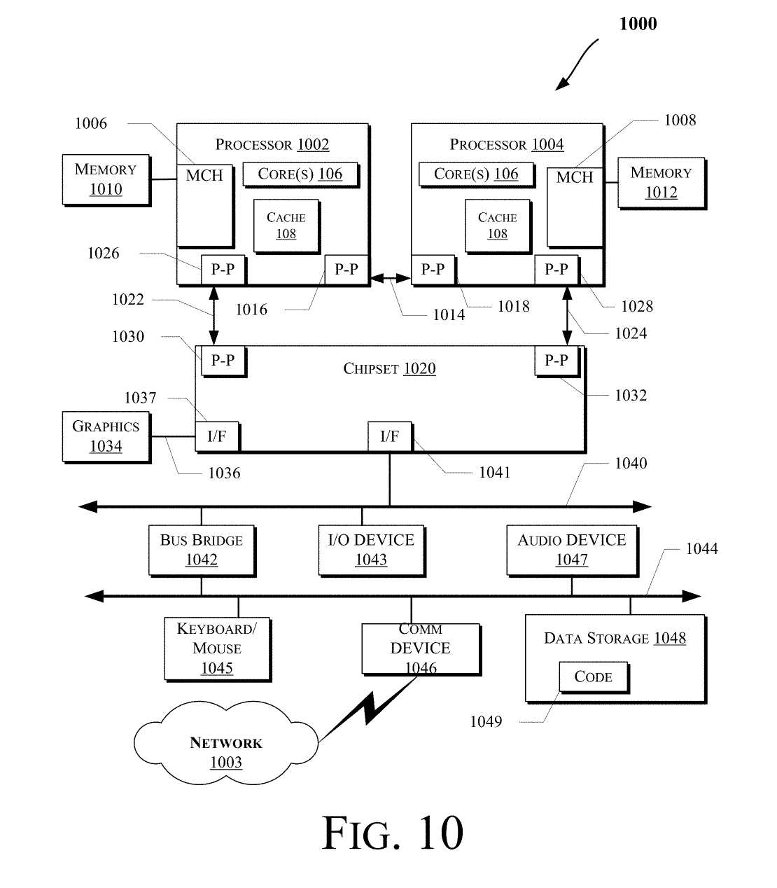

FIG. 10 illustrates an information processing system 1000 that is arranged in a point-to-point (PtP) configuration, according to an example. In particular, FIG. 10 shows a system where processors, memory, and input/output devices are interconnected by a number of point-to-point interfaces. As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertains to further examples.

Example 1 is automatic false pupil contact lens comprising a body formed from an optically translucent material and a coating on the body formed from at least one of a photochromatic material or an electrochromatic material that, in response to an input, is to change between a first state in which the coating is optically translucent and a second state in which the coating is optically opaque.

In Example 2, the subject matter of Example 1 can optionally include an arrangement in which the body is formed from at least one of a polymer material or a glass material.

In Example 3, the subject matter of any one of Examples 1-2 can optionally include an arrangement in which the coating comprises a photochromatic material arranged in a plurality of concentric rings and the coating comprises a photosensitivity which varies between the respective concentric rings.

In Example 4, the subject matter of any one of Examples 1-3 can optionally include an arrangement in which the photosensitivity increases in successively larger concentric rings.

In Example 5, the subject matter of any one of Examples 1-4 can optionally include an arrangement in which the coating comprises a photosensitivity which increases as a function of distance from a central point on the body.

In Example 6, the subject matter of any one of Examples 1-5 can optionally include an arrangement in which the coating comprises an electrochromatic material arranged in a plurality of concentric rings.

In Example 7, the subject matter of any one of Examples 1-6 can optionally include circuitry to selectively apply an electrical impulse to one or more of the concentric rings in response to a signal.

In Example 8, the subject matter of any one of Examples 1-7 can optionally include an arrangement in which the coating comprises an electrosensitivity which varies between the respective concentric rings and the electrical impulse applied to the concentric rings varies as a function of the electrosensitivity of the coating in the respective concentric rings.

In Example 9, the subject matter of any one of Examples 1-8 can optionally include an arrangement in which the coating comprises an electrosensitivity which is consistent between the respective concentric rings and the electrical impulse applied to the concentric rings is consistent across the respective concentric rings.

In Example 10, the subject matter of any one of Examples 1-9 can optionally include an arrangement in which the coating comprises a photosensitivity which increases as a function of distance from a central point on the body.

Example 11 is an electronic device, comprising at least one light sensor to detect an ambient light condition and a controller comprising logic, at least partially including hardware logic, to receive an input from the at least one light sensor, wherein the input reflects the ambient light condition, determine an appropriate pupil size for the ambient light condition, and in response to a determination that a difference between the appropriate pupil size and a current pupil size is not within a threshold, to generate a pupil size signal to be transmitted to an automatic false pupil contact lens.

In Example 12 the subject matter of Example 11 can optionally include an arrangement in which the controller further comprises logic, at least partially including hardware logic, to form a time series data of ambient light condition data collected by the at least one light sensor.

In Example 13 the subject matter of any one of Examples 11-12 can optionally include logic, at least partially including hardware logic, to apply a smoothing factor to the time series data of ambient light conditions.

In Example 14 the subject matter of any one of Examples 11-13 can optionally include an arrangement in which the logic to determine an appropriate pupil size for the ambient light condition further comprises logic, at least partially including hardware logic, to implement a training process to receive a first output from the at least one light sensor, wherein the input reflects the ambient light condition, receive a second input from a user of the electronic device, wherein the second input comprises an instruction to adjust a pupil size of the automatic false pupil contact lens, and receive a third input from a user of the electronic device, wherein the third input comprises an indication that the pupil size of the automatic false pupil contact lens is appropriate for the user.

In Example 15 the subject matter of any one of Examples 11-14 can optionally include an arrangement in which the logic to determine an appropriate pupil size for the ambient light condition further comprises logic, at least partially including hardware logic, to implement a training process to determine the pupil size of the automatic false pupil contact lens that is appropriate for the user and record in a machine readable memory the output of the at least one light sensor in logical association with the pupil size of the automatic false pupil contact lens that is appropriate for the user.

In Example 16 the subject matter of any one of Examples 11-15 can optionally include a sensor to determine a current pupil size on the automatic false pupil contact lens.

In Example 17 the subject matter of any one of Examples 11-16 can optionally include a receiver to receive a current pupil size on the automatic false pupil contact lens.

In Example 18 the subject matter of any one of Examples 11-17 can optionally include a transmitter to transmit the pupil size signal to the automatic false pupil contact lens.

In Example 19 the subject matter of any one of Examples 11-18 can optionally include an arrangement in which in response to receiving the pupil size signal, the automatic false pupil contact lens applies an electrical impulse to an electrochromatic coating on a portion of the automatic false pupil contact lens.

In Example 20 the subject matter of any one of Examples 11-19 can optionally include an arrangement in which the electrical impulse causes a change in a dimension of a pupil portion of the automatic false pupil contact lens.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An automatic false pupil contact lens, comprising:
a body formed from an optically translucent material; and
a coating on the body formed from at least one of a photochromatic material or an electrochromatic material that, in response to an input, is to change between a first state in which the coating is optically translucent and a second state in which the coating is optically opaque.

2. The automatic false pupil contact lens of claim 1, wherein the body is formed from at least one of a polymer material or a glass material.

3. The automatic false pupil contact lens of claim 1, wherein:
the coating comprises a photochromatic material arranged in a plurality of concentric rings; and
the coating comprises a photosensitivity which varies between the respective concentric rings.

4. The automatic false pupil contact lens of claim 3, wherein the photosensitivity increases in successively larger concentric rings.

5. The automatic false pupil contact lens of claim 1, wherein the coating comprises a photosensitivity which increases as a function of distance from a central point on the body.

6. The automatic false pupil contact lens of claim 1, wherein:
the coating comprises an electrochromatic material arranged in a plurality of concentric rings.

7. The automatic false pupil contact lens of claim 6, further comprising circuitry to:
selectively apply an electrical impulse to one or more of the concentric rings in response to a signal.

8. The automatic false pupil contact lens of claim 7, wherein:
the coating comprises an electrosensitivity which varies between the respective concentric rings; and
the electrical impulse applied to the concentric rings varies as a function of the electrosensitivity of the coating in the respective concentric rings.

9. The automatic false pupil contact lens of claim 7, wherein:
the coating comprises an electrosensitivity which is consistent between the respective concentric rings; and
the electrical impulse applied to the concentric rings is consistent across the respective concentric rings.

10. The automatic false pupil contact lens of claim 6, wherein the coating comprises a photosensitivity which increases as a function of distance from a central point on the body.

11. An electronic device, comprising:
at least one light sensor to detect an ambient light condition; and
a controller comprising logic, at least partially including hardware logic, to:
receive an input from the at least one light sensor, wherein the input reflects the ambient light condition;
determine an appropriate pupil size for the ambient light condition; and
in response to a determination that a difference between the appropriate pupil size and a current pupil size is not within a threshold, to generate a pupil size signal to be transmitted to an automatic false pupil contact lens.

12. The electronic device of claim 11, wherein the controller further comprises logic, at least partially including hardware logic, to:
form a time series data of ambient light condition data collected by the at least one light sensor.

13. The electronic device of claim 12, wherein the controller further comprises logic, at least partially including hardware logic, to:
apply a smoothing factor to the time series data of ambient light conditions.

14. The electronic device of claim 11, wherein the logic to determine an appropriate pupil size for the ambient light condition further comprises logic, at least partially including hardware logic, to implement a training process to:
receive a first output from the at least one light sensor, wherein the input reflects the ambient light condition;
receive a second input from a user of the electronic device, wherein the second input comprises an instruction to adjust a pupil size of the automatic false pupil contact lens; and
receive a third input from a user of the electronic device, wherein the third input comprises an indication that the pupil size of the automatic false pupil contact lens is appropriate for the user.

15. The electronic device of claim 14, wherein the logic to determine an appropriate pupil size for the ambient light condition further comprises logic, at least partially including hardware logic, to implement a training process to:
determine the pupil size of the automatic false pupil contact lens that is appropriate for the user; and
record in a machine readable memory the output of the at least one light sensor in logical association with the pupil size of the automatic false pupil contact lens that is appropriate for the user.

16. The electronic device of claim 11, wherein the electronic device further comprises:
a sensor to determine a current pupil size on the automatic false pupil contact lens.

17. The electronic device of claim 11, wherein the controller further comprises:
a receiver to receive a current pupil size on the automatic false pupil contact lens.

18. The electronic device of claim 11, further comprising:
a transmitter to transmit the pupil size signal to the automatic false pupil contact lens.

19. The electronic device of claim 18, wherein:
in response to receiving the pupil size signal, the automatic false pupil contact lens applies an electrical impulse to an electrochromatic coating on a portion of the automatic false pupil contact lens.

20. The electronic device of claim 19, wherein the electrical impulse causes a change in a dimension of a pupil portion of the automatic false pupil contact lens.
